(19) United States
(12) Patent Application Publication
(10) Pub. No.: US 2017/0086383 A1
(43) Pub. Date: Mar. 30, 2017

(54) Lawn Care Assembly

(71) Applicant: Gary Williams, SR., Georgetown, TX (US)

(72) Inventor: Gary Williams, SR., Georgetown, TX (US)

(21) Appl. No.: 14/871,400

(22) Filed: Sep. 30, 2015

(51) Int. Cl. A01G 1/12; A01D 7/00

(52) U.S. Cl. CPC A01G 1/125; A01D 7/00

(57) ABSTRACT

A lawn care assembly for removing debris from a lawn includes a roller that may be urged across a support surface. A plurality of spikes is provided. Each of the spikes is coupled to the roller. Each of the spikes may pierce debris on the support surface thereby facilitating the debris to be removed from the support surface when the roller is urged across the support surface.

### BACKGROUND OF THE DISCLOSURE

### Field of the Disclosure

The disclosure relates to lawn care devices and more particularly pertains to a new lawn care device for removing debris from a lawn.

### SUMMARY OF THE DISCLOSURE

An embodiment of the disclosure meets the needs presented above by generally comprising a roller that may be urged across a support surface. A plurality of spikes is provided. Each of the spikes is coupled to the roller. Each of the spikes may pierce debris on the support surface thereby facilitating the debris to be removed from the support surface when the roller is urged across the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a lawn care assembly according to an embodiment of the disclosure.

FIG. 2 is a front view of an embodiment of the disclosure.

FIG. 3 is a right side view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DESCRIPTION OF THE PREFERRED EMBODIMENT

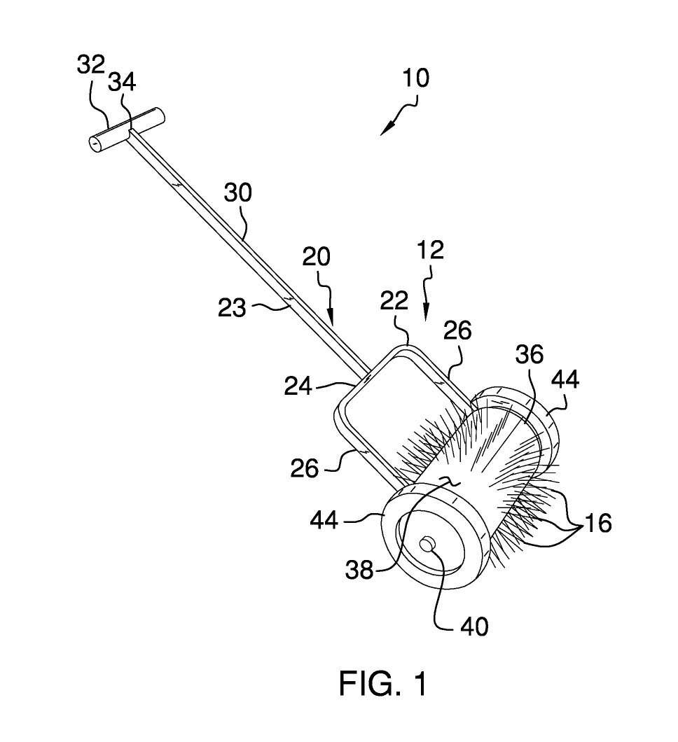

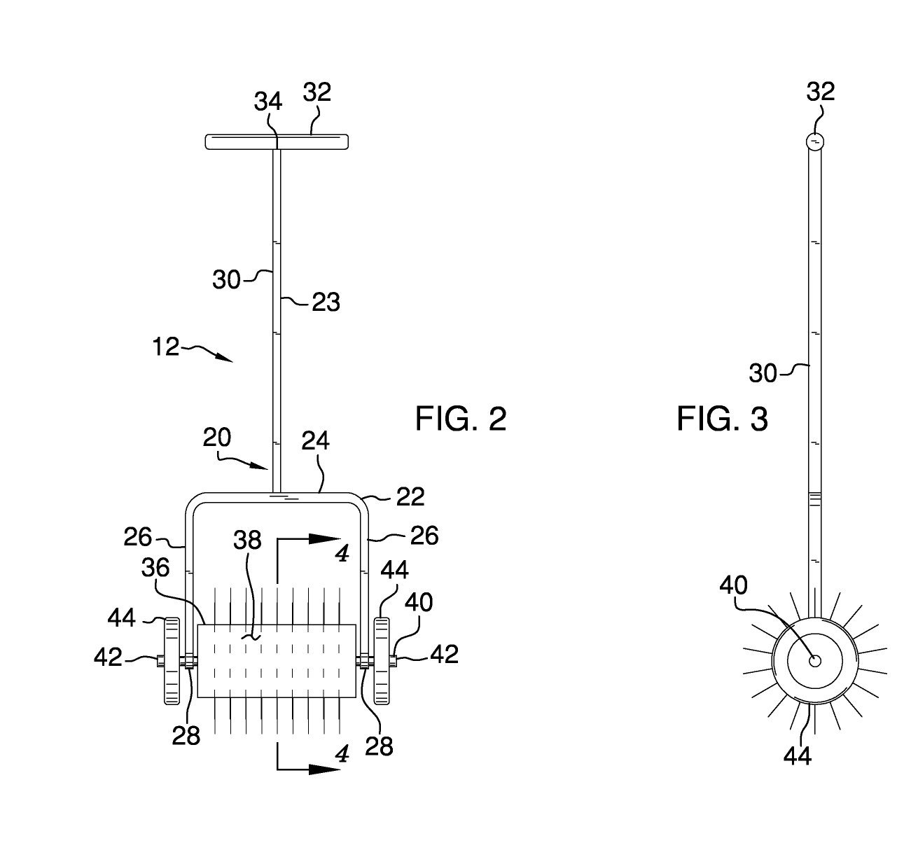

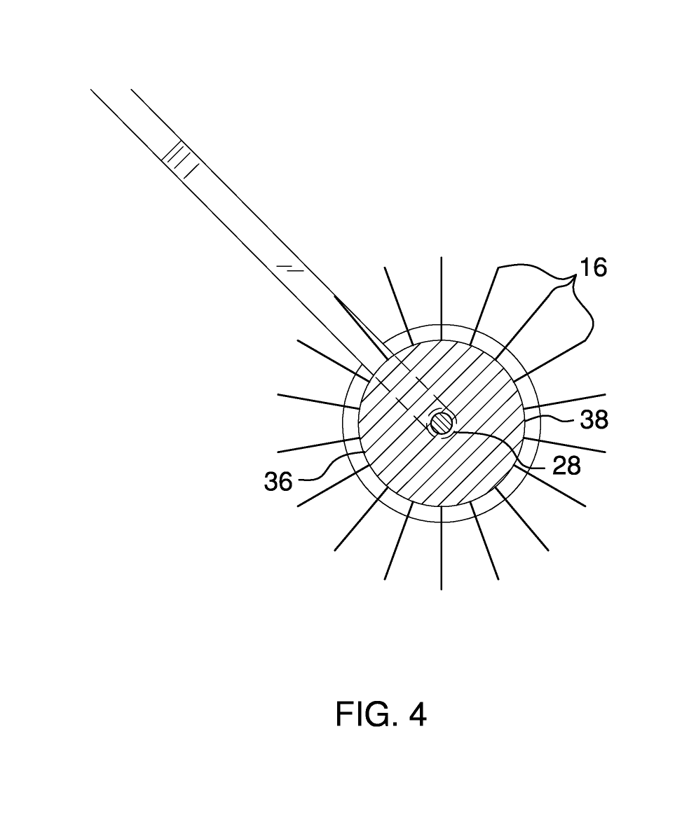

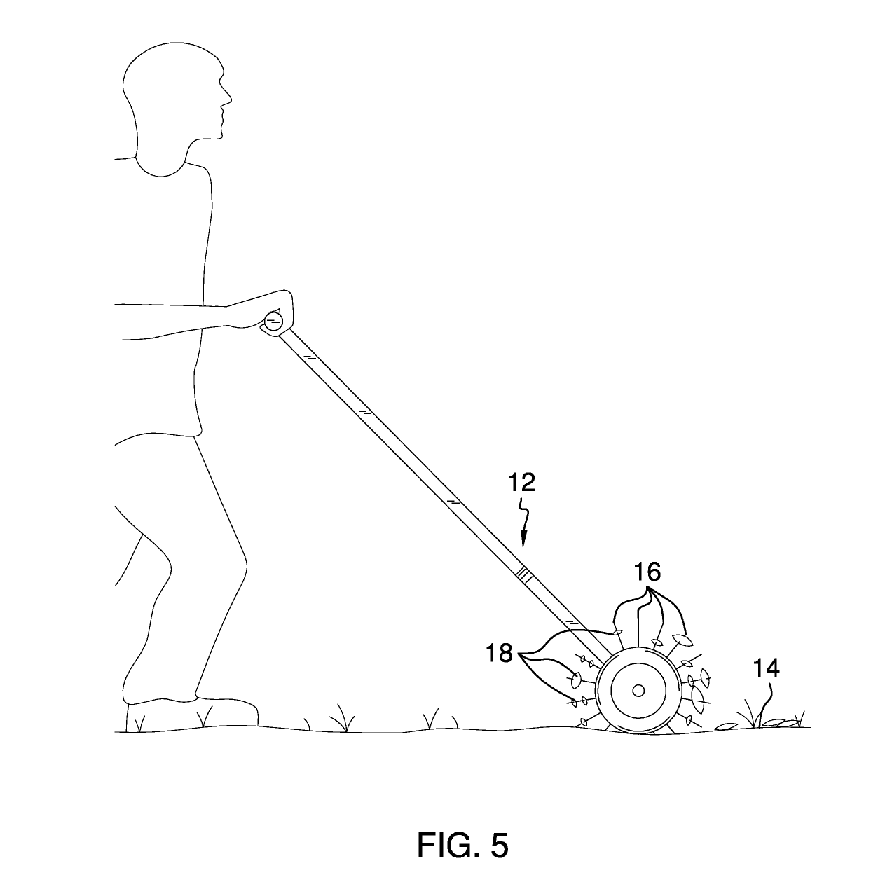

With reference now to the drawings, and in particular to FIGS. 1 through 5 thereof, a new lawn care device embodying the principles and concepts of an embodiment of the disclosure and generally designated by the reference numeral 10 will be described.

As best illustrated in FIGS. 1 through 5, the lawn care assembly 10 generally comprises a roller 12 that may be urged across a support surface 14. A plurality of spikes 16 is provided and each of the spikes 16 is coupled to the roller 12. Each of the spikes 16 pierce debris 18 on the support surface 14 thereby facilitating the debris 18 to be removed from the support surface 14 when the roller 12 is urged across the support surface 14. The support surface 14 may comprise ground and the debris 18 may comprise leaves or the like.

The roller 12 comprises a handle 20 that may be gripped. The handle 20 includes a yoke 22 and a grip 23. The yoke 22 has a central member 24 and a pair of lateral members 26. Each of the lateral members 26 is coupled to and extends away from the central member 24. The lateral members 26 are spaced apart from each other and each of the lateral members 26 has a distal end 28 with respect to the central member 24.

The grip 23 has a first member 30 and a second member 32. The first member 30 is coupled to and extends away from the central member 32. The first member 30 has a distal end 34 with respect to the central member 32. The second member 32 is coupled to the distal end 34 of the first member 30 and the second member 32 is oriented perpendicular to the first member 30. Thus, the second member 32 may be gripped.

A cylinder 36 is rotatably coupled to the yoke 22 such that the cylinder 36 may roll along the support surface 14. The cylinder 36 has an outer surface 38. An axle 40 extends longitudinally through the cylinder 36. The axle 40 rotatably engages each of the lateral members 26 such that the cylinder 36 extends between the lateral members 26. The axle 40 has a pair of ends 42 and each of the ends 42 extends through an associated one of the lateral members 26. The axle 40 is positioned proximate the distal end 28 of each of the lateral members 26.

A pair of wheels 44 is provided. Each of the wheels 44 is rotatably coupled to the axle 40 and each of the wheels 44 may roll along the support surface 14. Each of the wheels 44 is positioned on an associated one of the ends of the axle 40. Each of the wheels 44 may have a diameter that is greater than a diameter of the cylinder 36. Thus, the outer surface 38 of the cylinder 36 may be spaced from the support surface 14 when the roller 12 is rolled along the support surface 14. Each of the spikes 16 is positioned on the outer surface 38 of the cylinder 36. The spikes 16 are spaced apart from each other and are distributed around the cylinder 36.

In use, the handle 20 is gripped and the roller 12 is rolled along the support surface 14. Each of the spikes 16 pierces the debris 18 such that the debris 18 is retained on the spikes 16. The roller 12 is rolled along the support surface 14 until all of the debris 18 has been removed from the support surface 14. The debris 18 is removed from the spikes 16 when the spikes 16 become full with the debris 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A lawn care assembly comprising:
a roller, said roller comprising a yoke having a pair of lateral members;
a cylinder being rotatably coupled to said yoke wherein said cylinder is configured to roll along the support surface, said cylinder having an outer surface;
an axle extending longitudinally through said cylinder, said axle rotatably engaging each of said lateral members such that said cylinder extends between said lateral members, said axle having a pair of ends, each of said ends extending through an associated one of said lateral members;
a pair of wheels, each of said wheels being rotatably coupled to said axle wherein each of said wheels is configured to roll along the support surface, each of said wheels being positioned on an associated one of said ends of said axle such that each of said pair of lateral members is positioned between said cylinder and an associated one of said wheels; and
a plurality of spikes, each of said spikes being coupled to said roller such that each of said spikes is configured to pierce debris on a support surface thereby facilitating the debris to be removed from the support surface when said roller is urged across the support surface.

2. The assembly according to claim 1, wherein said roller includes a handle having a grip, said yoke having a central member, each of said lateral members being coupled to and extending away from said central member, said lateral members being spaced apart from each other, each of said lateral members having a distal end with respect to said central member.

3. The assembly according to claim 2, wherein said grip has a first member and a second member, said first member being coupled to and extending away from said central member, said first member having a distal end with respect to said central member, said second member being coupled to said distal end of said first member wherein said second member is configured to be gripped.

4. (canceled)

5. (canceled)

6. (canceled)

7. The assembly according to claim 1, wherein each of said spikes is positioned on said outer surface of said cylinder, said spikes being spaced apart from each other and being distributed around said cylinder.

8. A lawn care assembly comprising:
a roller; and
a plurality of spikes, each of said spikes being coupled to said roller such that each of said spikes is configured to pierce debris on a support surface thereby facilitating the debris to be removed from the support surface when said roller is urged across the support surface, said roller comprising:
a handle being configured to be gripped, said handle comprising a yoke and a grip, said yoke having a central member and a pair of lateral members, each of said lateral members being coupled to and extending away from said central member, said lateral members being spaced apart from each other, each of said lateral members having a distal end with respect to said central member, said grip having a first member and a second member, said first member being coupled to and extending away from said central member, said first member having a distal end with respect to said central member, said second member being coupled to said distal end of said first member wherein said second member is configured to be gripped,
a cylinder being rotatably coupled to said yoke wherein said cylinder is configured to roll along the support surface, said cylinder having an outer surface,
an axle extending longitudinally through said cylinder, said axle rotatably engaging each of said lateral members such that said cylinder extends between said lateral members, said axle having a pair of ends, each of said ends extending through an associated one of said lateral members, and
a pair of wheels, each of said wheels being rotatably coupled to said axle wherein each of said wheels is configured to roll along the support surface, each of said wheels being positioned on an associated one of said ends of said axle such that each of said pair of lateral members is positioned between said cylinder and an associated one of said wheels; and
each of said spikes being positioned on said outer surface of said cylinder, said spikes being spaced apart from each other and being distributed around said cylinder.
